(19) United States
(12) Patent Application Publication
(10) Pub. No.: US 2008/0191652 A1
(43) Pub. Date: Aug. 14, 2008

(54) Heat Treatment of Metal Work Pieces

(75) Inventor: Mario Jurack, Kleve (DE)

Correspondence Address: CANTOR COLBURN, LLP, 20 Church Street, 22nd Floor, Hartford, CT, 06103, US

(73) Assignee: IPSEN INTERNATIONAL GMBH, KLEVE (DE)

(21) Appl. No.: 11/911,821

(22) PCT Filed: Mar. 29, 2006
(86) PCT No.: PCT/EP2006/002842

§ 371 Date: Feb. 20, 2008

(30) Foreign Application Priority Data
Apr. 18, 2005 (DE) 10 2005 017 906.1

(51) Int. Cl. H02P 25/22; H02P 25/18; C21D 9/00

(52) U.S. Cl. 318/481; 148/559

(57) ABSTRACT

The invention relates to a method for heat-treating metal work pieces, whereby a cooling gas flow is produced in a vacuum furnace by means of a fan, driven by a three-phase AC motor, in order to quench the work pieces. The aim of the invention is to improve the heat treatment of metal work pieces in such a manner as to improve the quenching in a simple and inexpensive manner. For this purpose, the three-phase AC motor comprises first three-phase windings designed for a lower supply voltage and second three-phase windings designed for a higher supply voltage. The three-phase AC motor is operated with the first three-phase windings until a minimum pressure defined in terms of the motor output is reached in the vacuum furnace and with the second three-phase windings until a minimum pressure defined in terms of the motor output is reached or exceeded in the vacuum furnace.

The present invention relates to a method for heat treatment of metal work pieces, whereby a cooling gas flow is produced in a vacuum furnace by means of a fan driven by a three-phase AC motor, in order to quench the work pieces.

At the heat treatment of metal work pieces such as hardening, tempering or annealing, vacuum furnaces are used in which the work pieces are cooled by a gaseous medium, for instance nitrogen, after heating. Compared to conventional quenching in an oil or salt bath, such quenching by means of gas has the advantage that the work pieces are not contaminated, so that expensive cleaning measures that would otherwise be required, can be omitted. To achieve similar cooling effects with gas quenching as with oil or salt bath quenching, high cooling gas pressures are used which guarantee the desired heat transfer due to the increased gas density that is involved. However, a disadvantage is that high cooling gas pressures require complicated and expensive safety measures and in addition to that relatively much time for flooding or evacuating the vacuum furnace.

A further disadvantage of high-pressure gas quenching is that a comparatively high shaft power is required for a fan that produces the cooling gas flow in the vacuum furnace, in order to provide the required cooling gas velocity for the load moments that are given at these high pressures. A high shaft power of a fan equally necessitates a high motor output of an electric motor driving the fan, which motor normally is a three-phase AC motor. Motors which are usual in this case are three-phase AC motors having a rated motor output of e.g. 220 kW. With a usual supply voltage in the three-phase net of about 400 V, a rated motor output of 220 kW will result in a rated motor current of about 400 A. At the start of the fan a start-up current of about 3600 A will be produced due to the occurring current pulses, which current pulses are usually nine times that of the rated motor current in the normal condition of the cooling gas.

Such high currents regularly lead to mains disturbances and cause a high degree of wear, above all at the connection points of the three-phase AC motor. To avoid this, start-up devices are normally used which effect a so-called soft start of the three-phase AC motor by limiting the start-up current, for instance to five or six times that of the rated motor current. The provision of start-up devices, so-called LCPs (Low Current Power), requires the use of relatively huge switching cabinets and their accessories, low power transformers, relays, disconnectors and the like which are labour-intensive and costly and for this reason dissatisfying regarding their economic efficiency.

Though it is possible at a so-called soft start of the electric motor driving the fan to quench the work pieces to be treated already at low furnace pressures, i.e. still during the flooding of the vacuum furnace with cooling gas, there exists a lower time limit for the beginning of the quenching operation. This can be attributed to the fact that prior to the start of the fan the vacuum furnace must be flooded for obtaining a certain minimum pressure with respect to the motor supply voltage, in order to avoid the occurrence of spark overs in the supply voltage which for instance cause damage to the insulation. The minimum pressure which can be determined by the so-called Paschen curves amounts as a rule to about 750 mbar for three-phase AC motors having a motor supply voltage of about 400 V.

Since the fan can be started only upon reaching the minimum pressure during flooding the vacuum furnace with cooling gas, the quenching time and thus the obtainable quenching effect are additionally negatively influenced due to the largely unavoidable start-up time.

In view of this prior art, the invention is based on the problem of further developing a method for the heat treatment of metal work pieces in such a manner that an improved quenching can be achieved easily and inexpensively, while reducing the material and labour which are otherwise involved in conventional start-up devices.

In a method comprising the above-mentioned features this problem is solved according to the invention by the three-phase AC motor comprising first three-phase windings designed for a lower supply voltage and second three-phase windings designed for a higher supply voltage, where the three-phase AC motor is operated with the first three-phase windings until a minimum pressure defined in terms of the motor output is reached in the vacuum furnace and with the at least second three-phase windings until a minimum pressure defined in terms of the motor output is reached or exceeded in the vacuum furnace.

The invention is based on the finding that an improved quenching is attainable by a smaller start-up current. According to the invention there is first started a three-phase AC motor having a smaller rated output and accordingly a reduced start-up current, by the first three-phase windings which are adapted for a lower supply voltage, so that an expensive start-up device which effects a so-called soft start can be omitted. But due to the pressure which is still low in the vacuum furnace and due to the accompanying low density of the cooling gas, the lower motor output in this phase is sufficient for having the fan started which is driven by the three-phase AC motor. Upon reaching the minimum pressure in the vacuum furnace the three-phase AC motor is driven at a higher rated motor output corresponding to the second three-phase windings which are correspondingly designed for a higher supply voltage. In addition to the first and second three-phase windings the three-phase AC motor may include further three-phase windings which are in turn designed for higher supply voltages. Upon reaching corresponding characteristic pressure values in the vacuum furnace the three-phase AC motor is operated with a higher motor output corresponding to these further windings. The following description is made with reference to a three-phase AC motor having first and second three-phase windings, but it is not limited to this number of windings. Since at this point of time the three-phase AC motor and consequently the fan is already operated with its nominal rotational speed, the shaft power that is required for the quenching operation is immediately available upon switching over to or connecting said higher rated motor output according to the invention, without the occurrence of any other negative influence on the quenching effect that would otherwise be caused by the time loss which is due to the start-up operation. In this context it is important that as a consequence of the fact that the fan is already running at the nominal rotational speed prior to reaching the minimum pressure in the vacuum furnace, kinetic energy is stored in the fan which kinetic energy is noticed as a flywheel effect when utilizing the second three-phase winding corresponding to the higher rated motor output.

The process management according to the invention additionally contributes to a more favourable current consumption concerning the aspect of economic efficiency, and this due to the lower start-up currents at the use of the first three-phase windings in accordance with a lower rated motor output. By the use according to the invention of the first and second three-phase windings on part of the three-phase AC motor there is given in addition to a reduction of the start-up current at least by factor 2 at the use of the first three-phase windings a reduction of the structural dimensions of the switching cabinets, which dimensions would be given in the case of existing complicated start-up devices, especially so-called LCPs and their accessories, which start-up devices are unnecessary according to the invention.

In an advantageous form of the invention the second three-phase windings are connected in addition to the first three-phase windings upon reaching or exceeding the minimum pressure in the vacuum furnace which is determined in terms of its motor output. Advantageously, the connection of the second three-phase windings of the three-phase AC motor in addition to the first three-phase windings of the three-phase AC motor is effected by a parallel connection of the two three-phase windings, while advantageously coordinating the two three-phase windings with respect to the phase balance, rotational speed and the like. Advantageously, a synchronizing device is used for this coordination.

In a further preferred form of the invention the mains voltage is applied to the three-phase AC motor, and for the first three-phase windings this mains voltage is reduced by a transformer from the higher supply voltage to the lower supply voltage. A comparatively low-cost voltage transformation is given thereby. Advantageously, the first three-phase windings which are designed for a low supply voltage are three-phase windings which are designed for about 25 kW to about 40 kW at a supply voltage of 230 V and which are operated with a series transformer, preferably a so-called autotransformer, for a higher three-phase AC mains supply voltage of about 400 V corresponding to the higher supply voltage. Advantageously, the second three-phase windings are three-phase windings designed for and operated at rated motor outputs of about 120 kW to about 140 kW at a three-phase AC mains supply voltage of approx 400 V.

In a concrete form of execution of the invention the three-phase AC motor includes two identically designed three-phase windings of 25 kW each at a supply voltage of 230 V, and 80 kW at a supply voltage of 400 V, which three-phase windings constitute the first and second three-phase windings. At a start-up according to the invention and until reaching a predetermined minimum pressure in the vacuum furnace, the so-called start-up in vacuum, the start-up current of the first three-phase windings designed for a lower supply voltage, in the present case approximately 230 V, will halve when the connection is made according to the invention. According to the invention, for the operation in the flooded vacuum furnace the first and the second three-phase windings are then operated in parallel with 50 kW at 230 V and with 160 kW at 400 V, and when operated at 230 V utilizing a transformer at the 400 V net. In this concrete form of execution of the invention the three-phase AC motor includes a total number of twelve connection terminals for the two mutually separated first and second three-phase windings.

According to a preferred embodiment of the invention, the second three-phase windings are switched over to the first three-phase windings in dependence of a prevailing pressure in the vacuum furnace, in order to guarantee a process management which is as simple as possible and which can be automated. In a further development of the invention there is also proposed a minimum pressure within a range from about 500 mbar to about 1200 mbar, preferably of about 750 mbar, so that the motor output of the most commonly used three-phase AC motors for fans used in vacuum furnaces is met.

To be able to use powerful three-phase AC motors the three-phase AC motor is, according to a further feature of the invention, water-cooled. A simple regulation of the cooling gas flow can be achieved by the fact that the rotational speed of the fan above the minimum pressure is varied in an advantageous manner in dependence of the desired cooling gas rate. Finally, it is proposed that the fan is operated at pressures in the vacuum furnace of up to 40 bar, in order to guarantee cooling gas pressures corresponding to the respective requirements at a sufficient quenching performance.

Advantageously, a subject of the present invention further is a three-phase AC motor including a first three-phase winding designed for a lower supply voltage and a second three-phase supply voltage designed for a higher supply voltage, where said motor can be driven in dependence of characteristic operation parameters of devices driven by it, using the first three-phase winding and using the second three-phase winding when the characteristic operation parameters of the devices driven by the motor are reached or exceeded. In doing so, the second three-phase windings are connectible in parallel upon reaching or exceeding the characteristic operation parameters of the devices that are driven by the three-phase AC motor directly and/or indirectly. Preferably, the first three-phase windings of the three-phase AC motor can be operated via a transformer designed for a lower supply voltage at the higher supply voltage, said transformer downwardly transforming the higher supply voltage to the lower supply voltage.

Further details, features and advantages of the subject of the present invention will become apparent from the following exemplary description of the case hardening of metal work pieces.

Case hardening serves for giving the surface layer of metal work pieces a considerably higher hardness and accordingly better mechanical properties to the work piece as a whole. To this end, the surface layer is first of all enriched with carbon and/or nitrogen, depending on the required properties of use, and thereafter quenched from an appropriate hardening temperature to room temperature or a lower temperature. A case hardening operation which is satisfactory from the procedural and practical aspects can be achieved if both the carburization or carbonitriding and the subsequent quenching are performed in a vacuum furnace which allows an easy exchange of gaseous heat treatment media.

After the work pieces to be treated have for instance been carburized in the vacuum furnace, the hardening operation can be performed directly following the carburization, by evacuating the gaseous carburization medium and by subsequently flooding the vacuum furnace with an inert cooling gas, without the necessity of transferring the work pieces to a different furnace chamber. For hardening the work pieces an electrically driven fan is provided in the vacuum furnace, which fan produces a cooling gas flow having a cooling speed corresponding to the respective requirements. The cooling gas flow quenches the work pieces to be treated from the hardening temperature down to room temperature or even a lower temperature.

For driving the fan a three-phase AC motor is provided comprising two mutually separate three-phase windings. The first three-phase windings of the three-phase AC motor have a rated output of about 40 kW and are operated at a pressure in the vacuum furnace of less than 750 mbar at a supply voltage of 230 V. The second three-phase windings of the three-phase AC motor have a rated output of about 120 kW and are operated at a pressure in the vacuum furnace of more than 750 mbar at a supply voltage of about 400 V. By means of a transformer connected to the 400 V mains the supply voltage of the first three-phase windings of the three-phase AC motor is reduced to 230 V. As soon as a pressure of about 750 mbar is reached in the vacuum furnace during the flooding with cooling gas, the second three-phase windings operated with a supply voltage of about 400 V are added through a connection in parallel with the first three-phase windings which are operated via the transformer with a supply voltage of about 230 V. Until reaching the pressure of 750 mbar the motor output correspondingly is only one third of the motor output which is available upon reaching or exceeding the pressure of about 750 mbar in the vacuum furnace, corresponding to the ratio of the rated motor output of the first three-phase windings to the motor output of the second three-phase windings of the three-phase AC motor. This results in the fact that the start-up current of the three-phase AC motor will be halved compared to start-up currents otherwise present until a pressure of about 750 mbar is reached in the hardening furnace. Accordingly, this results in equally reduced start-up currents at the start of the fan, so that the mains supply is not negatively influenced in this way.

1. Method for heat treatment of metal work pieces in which a cooling gas flow is produced in a vacuum furnace by a fan that is driven by a three-phase AC motor, for quenching the work pieces, characterized in
that the three-phase AC motor includes first three-phase windings designed for a lower supply voltage and at least second three-phase windings designed for a higher supply voltage, wherein the three-phase AC motor is operated using the first three-phase windings until a minimum pressure defined in terms of the motor output is reached in the vacuum furnace and using the at least second three-phase windings when a minimum pressure defined in terms of the motor output is reached or exceeded in the vacuum furnace.

2. Method according to claim 1, characterized in that the second three-phase windings are added to the first three-phase windings preferably by a parallel connection when the minimum pressure defined in terms of the motor output is reached or exceeded in the vacuum furnace.

3. Method according to claim 1 or claim 2, characterized in that the higher supply voltage is applied to the three-phase AC motor and that the first three-phase windings of the three-phase AC motor are operated with a supply voltage that has been reduced from the higher supply voltage to the lower supply voltage by a transformer.

4. Method according to one of the claims 1 to 3, characterized in that the first three-phase windings are designed for operation at a supply voltage of about 230 V and the second three-phase windings are designed for operation at a supply voltage of about 400 V.

5. Method according to one of the claims 1 to 4, characterized in that the second three-phase windings of the three-phase AC motor are connected to the first three-phase windings of the three-phase AC motor, in dependence of the pressure prevailing in the vacuum furnace.

6. Method according to one of the claims 1 to 5, characterized by a minimum pressure in the vacuum furnace within a range of about 500 mbar to 1200 mbar, preferably about 750 mbar.

7. Method according to one of the claims 1 to 6, characterized in that the first three-phase windings of the three-phase AC motor are designed for motor outputs of approximately 25 kW to approximately 40 kW at supply voltages of approximately 230 V.

8. Method according to one of the claims 1 to 7, characterized in that the second three-phase windings of the three-phase AC motor are designed for motor outputs of approximately 120 kW to approximately 140 kW at supply voltages of approximately 400 V.

9. Method according to one of the claims 1 to 8, characterized in that the three-phase AC motor is water-cooled.

10. Method according to one of the claims 1 to 9, characterized in that the rotational speed of the fan above the minimum pressure in the vacuum furnace is varied in dependence of the desired cooling gas velocity.

11. Method according to one of the claims 1 to 10, characterized in that the fan is operated at pressures in the vacuum furnace of up to 40 bar.

12. Method according to one of the claims 1 to 11, characterized by the subsequent steps for quenching the work pieces:
a) initiating the gas quenching operation by starting the three-phase AC motor of the fan at a pressure in the vacuum furnace lower than 750 mbar, using the first three-phase windings of the three-phase AC motor,
b) raising the output of the fan to the nominal output,
c) flooding the vacuum furnace with the quenching gas and setting the quenching pressure in the quenching chamber to a value of between 1 bar and 40 bar,
d) substantially simultaneously connecting the second three-phase windings of the three-phase AC motor to the first three-phase windings of the AC motor when a pressure in the vacuum furnace of about 750 mbar is reached, and
e) after the termination of the gas quenching operation, venting the quenching chamber to reach atmosphere pressure and removing the work pieces.

13. Three-phase AC motor including first three-phase windings designed for a lower supply voltage and at least second three-phase windings designed for higher supply voltages, wherein the three-phase AC motor can be operated with the first three-phase windings until a minimum pressure defined in terms of the motor output is reached in the vacuum furnace and with the at least second three-phase windings until a minimum pressure defined in terms of the motor output is reached or exceeding the vacuum furnace.

14. Three-phase AC motor according to claim 13, characterized in that the three-phase AC current includes two identically designed three-phase windings.
